(19) United States
(12) Patent Application Publication
(10) Pub. No.: US 2006/0064557 A1
(43) Pub. Date: Mar. 23, 2006

(54) Interleaving data blocks

(76) Inventors: Stephen Gold, Fort Collins, CO (US); Mike P. Fleishmann, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/949,680

(22) Filed: Sep. 23, 2004

(51) Int. Cl. G06F 12/00

(52) U.S. Cl. 711/157; 711/114

(57) ABSTRACT

A method for interleaving includes presenting a physical storage device as a plurality of logical storage devices each having a unique address. Streams of data blocks are received via each address. The data blocks are interleaved. Instructions are routed to write the interleaved data blocks to the storage device in a single interleaving session.

### BACKGROUND

Storage devices such as tape drives are employed to back-up electronic data in network environments. Storage devices have evolved with greater capacity and back-up speeds to keep pace with the ever-growing network data storage needs. Some modern high performance storage devices can record large amounts of data every second. A single data source, however, cannot always transmit data to the storage device as fast as the storage device can record the data. That is to say, the storage device cannot be kept “streaming” by a single data source.

Where multiple data sources are connected over a local area network (LAN), individual data streams may combined and supplied concurrently to a storage device through a single storage server to keep the storage device streaming. A storage server interleaves the data streams to the storage device. LAN based interleaving is implemented through a special interleave back-up application running on the storage server. Where, however, data flow to the storage device is transmitted through a storage area network (SAN), there is no single point through which multiple data streams might be combined and supplied concurrently to a storage device on the SAN.

### DRAWINGS

FIG. 1 illustrates an exemplary environment in which embodiments of the present invention can be implemented.

FIG. 2. is an exemplary block diagram showing physical and logical components operating in the environment of FIG. 1 according to an embodiment of the present invention.

FIG. 3 is an exemplary block diagram showing the logical components of a media agent according to an embodiment of the present invention.

FIG. 4 is an exemplary block diagram showing the logical components of an interleave engine according to an embodiment of the present invention.

FIG. 5 is an exemplary flow diagram illustrating steps take to prepare a number of hosts for sending data blocks to be interleaved according to an embodiment of the present invention.

FIG. 6 is an exemplary flow diagram illustrating steps to interleave data blocks from multiple hosts in a single session.

### DESCRIPTION

Embodiments of the invention were developed in an effort to increase the rate of data flow from multiple sources through a storage area network (SAN) to a storage device. Embodiments will be described with reference to a SAN based tape drive back-up for multiple data sources. Embodiments, however, are not limited to use in SAN based tape back-ups but may be used in other applications and/or with other storage devices and mediums. The exemplary embodiments shown in the figures and described below illustrate but do not limit the invention. Other forms, details, and embodiments may be made and implemented. Hence, the following description should not be construed to limit the scope of the invention, which is defined in the claims that follow the description.

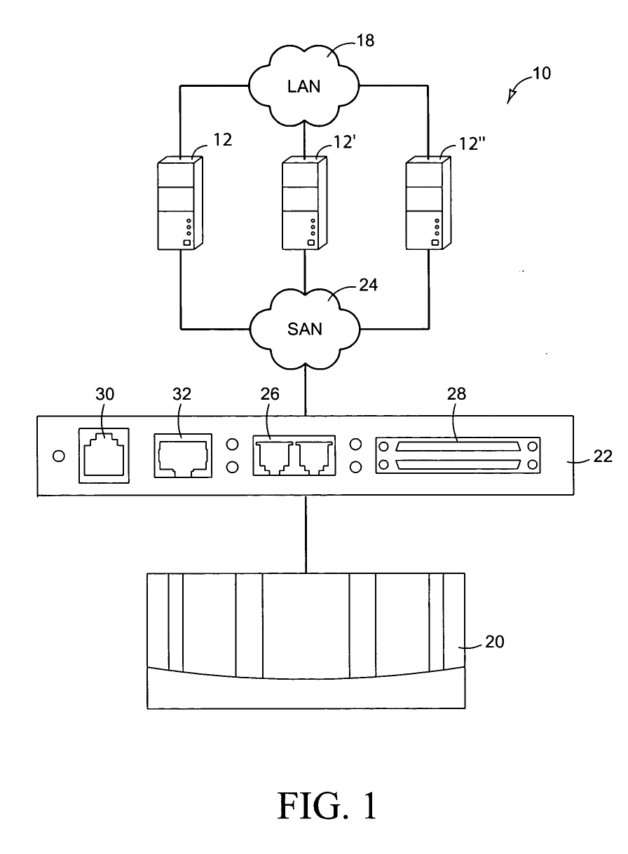

ENVIRONMENTS: FIG. 1 illustrates an exemplary network environment 10 in which various embodiments of the invention may be implemented. Environment 10 of FIG. 1 includes hosts 12, 12′, and 12″ interlinked by LAN (Local Area Network) 18. Environment 10 also includes storage device 20 and storage router 22. Described in more detail below, storage router 22 provides hosts 12, 12′, and 12″ with access to storage device 20 via SAN (Storage Area Network) 24. While environment 10 includes three hosts, hosts 12, 12′, and 12″, environment 10 can include any number of hosts.

Hosts 12, 12′, and 12″ (collectively referred to as hosts 12) are illustrated as network servers. However, hosts 12 represent generally any electronic devices capable of communicating with storage device 20 via SAN 24 and storage router 20 for the purposes of backing up electronic data. Storage device 20 represents generally any device capable of storing electronic data. Storage device 20 may, for example, be a tape drive or a tape library capable of storing electronic data sent from hosts 12. While storage router 22 is shown as a fibre channel to SCSI (Small Computer System Interface) router, storage router 22 represents any device capable of receiving data from hosts 12 and routing instructions to write that data to storage device 20.

As shown, storage router 22 includes storage network interface 26, storage device interface 28, Ethernet interface 30 and telnet interface 32. Storage network interface 26 represents hardware capable of receiving and transmitting data over a network such as SAN 24. In this case, network interface 28 is shown as a fibre channel interface. Storage device interface 28 represent hardware capable of receiving data from and transmitting data to storage device 20. Here, storage device interface is shown as a SCSI interface. Ethernet interface 30 and telnet interface 32 represent hardware capable of transmitting and receiving data related to the configuration of storage router 22. As shown, no devices are connected to interfaces 30 and 32.

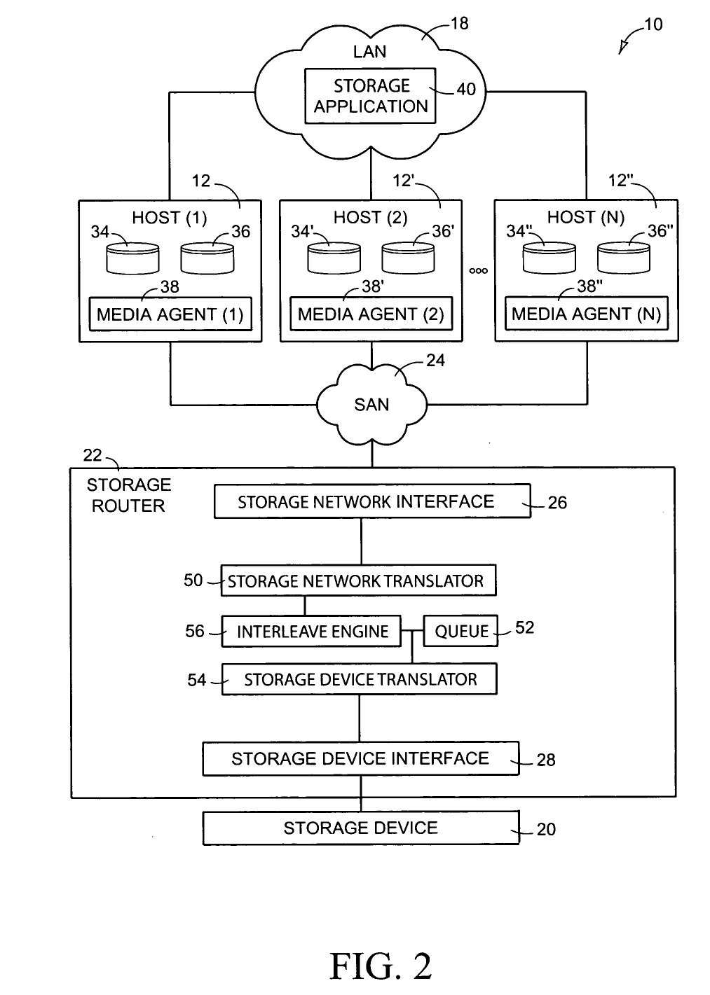

COMPONENTS: FIG. 2 is a block diagram illustrating the physical and logical components of environment 10. Host 12 includes data sources 34 and 36 and media agent 38. Similarly, host 12′ includes data sources 34′ and 36′ and media agent 38′ while host 12″ includes data sources 34″ and 36″ media agent 38″. Data sources 34, 34′, and 34″ (collectively referred to as data sources 34) represent generally any source of stored electronic data such as a hard drive or a collection of hard drives. Data sources 36, 36′, and 36″ (collectively referred to as data sources 36) also represent generally any source of stored electronic data. Each of data sources 36, for example, could be a mirror or snapshot of a respective data source 34.

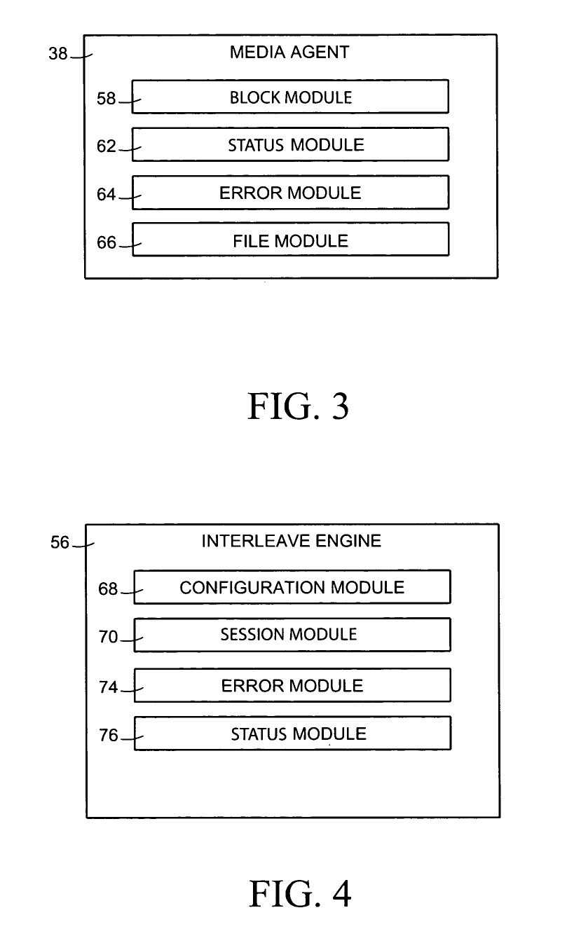

Media agents 38, 38′, and 38″ (collectively referred to as media agents 38) represent program instructions capable of sending data blocks from to storage device 20 over SAN 24. Media agents 38 are described in more detail below with respect to FIG. 3. Storage application 40 represents program instructions capable of coordinating the operations of media agents 38 to concurrently send data from hosts 12 to storage device 20 in a single session. While storage application 40 is shown operating somewhere on LAN 18, storage application 40 could be operating on one of hosts 12, 12′, or 12″. Alternatively, storage application 40 could be operating somewhere on SAN 24.

Storage router 22 is responsible for receiving data blocks from media agents 38 and routing instructions to write those data blocks to storage device 20. Storage router 22 is shown to include storage network interface 26, storage device interface 28 both of which were described above with reference to FIG. 1. Storage router 22 also includes network translator 50, queue 52, storage device translator 54, and interleave engine 56. Storage network translator 50 represents generally any hardware and/or program instructions capable of using storage network interface 26 to receive communications and of placing those communications in queue 52. These communications, for example could include data blocks. Queue 52 represents one or more physical or logical memory locations for providing temporary storage of communications received by storage router 22. Storage device translator 54 represents generally any hardware and/or program instructions capable of accessing communications placed in queue 52 by storage network translator 50 and utilizing storage device interface 28 to route those communications on to storage device 20. Storage device translator 54 is also responsible for using storage device interface 28 to receive communications form storage device 20 and to place those communications in queue 52. Similarly storage network translator 50 is also responsible for accessing communications placed in queue 52 by storage device translator 54 and to use storage network interface 28 to direct those communications over SAN 24 to their intended targets.

Assume, for example, that storage router 22 is a fibre channel to SCSI router. In this case, storage network translator 50 would be a fibre channel controller and would be responsible for utilizing storage network interface 50, a fibre channel interface, to receive and place data packets into queue 52—the data packets being sent by one or more of hosts 12. Storage device translator 54 would then be a SCSI controller responsible for accessing queue 52 and using storage device interface 28, a SCSI interface, to route the data packets to storage device 20.

Interleave engine 56 represents program instructions for identifying related data blocks within queue 52. Related data blocks are data bocks to be interleaved and written to storage device 20 in a single session. Related data blocks are data blocks received from related hosts. Related hosts are hosts, such as hosts 12, that have been selected to work together to send data blocks in a single session. Interleave engine 56 is responsible for interleaving the data blocks. In other words, interleave engine 56 is responsible for instructing storage device translator 54 to sequentially write the related data blocks to the storage device as those data blocks are received into queue 52. This may be on a first in first out basis. In other words, interleave engine 56 instructs storage device translator 56 to write the data blocks from queue 52 based on the chronological order on which the data blocks were placed in queue 52.

FIG. 3 is a block diagram illustrating an example of the logical components of a media agent 38 (FIG. 2). Media agent 38 is shown to include block module 58, status module 62, error module 64, and file module 66. Block module 58 represents program instructions capable of assembling data blocks in interleave format. A data block in interleave format, for example, may be a packet of data that includes a header that in some manner identifies the data block. A number of data blocks may be required to back-up a single electronic file. The header for a given data block then identifies the file the data block is from as well as that data block's position within the file. This allows the data blocks to be reassembled regardless of the order in which they are stored. Block module 58 is also responsible for sending a stream of data blocks to storage device 20 over SAN 24 (FIG. 2).

Status module 62 represents program instructions for requesting information concerning a data block sent to storage device 20. For example, where storage device 20 is a tape library, status module 62 could issue a status request for information from the tape library identifying the position or offset of a data block on a tape medium employed by the tape library. This “offset” information can be used to more quickly locate and retrieve a particular data block or group of data blocks making up a file. Error module 64 represents program instructions for receiving and acting upon error messages from storage router 22 or storage device 20. For example, upon receiving an error message, error module 64 may instruct block module 60 to pause or otherwise halt operation.

When coordinating the functions of media agents 38, storage application 40 may identify, for each media agent 38, a list of files to be backed up from a particular data source such as a mirror or snapshot disk. Referring back to FIG. 2, media sources 36 may be mirror or snapshot disks for media sources 34. In this case a case, file module 66 is used. File module 66 represents program instructions for resolving the raw data on a media source such as a mirror or snapshot disk into a file system structure thus to a list of data blocks for the for those files. In other words, when media agent 38 receives a list of files, file module 66 converts that list into a list of data blocks for block module 58 to assemble and send to storage device 20.

FIG. 4 is a block diagram illustrating an example of the logical components of interleave engine 56 (FIG. 2). Interleave engine 56 is shown to include configuration module 68, session module 70, error module 74, and status module 76. Configuration module 68 represents hardware and/or program instructions for presenting a storage device 20 as a plurality of logical storage devices each having a unique address—one unique address assigned to each host 12. Where, for example, storage device 20 is a sequential SCSI storage device capable of accepting one input stream at a time, configuration module 68 may present, for each host 12, a unique SCSI LUN (Logical Unit Address) mapped to storage device 20. In this manner, storage device 20 can be exposed to appear as a different logical storage device to each of hosts 12 allowing hosts 12 to send streams of data blocks to be backed-up in a single interleaving session. As used here, the phrase “interleaving session” refers to a period dedicated to the concurrent transfer of data from multiple disparate sources such as hosts 12 where the transferred data is to be interleaved and stored together on a common storage medium employed by a storage device such as storage device 20.

Session module 70 represents hardware and/or program instructions for interleaving data blocks received from associated hosts—that is—those hosts assigned an address presented by configuration module 68. Session module 70 is responsible for instructing storage device translator 54 to sequentially write data blocks to the storage device as those data blocks are received from associated hosts into queue 52 (FIG. 2). As noted above, this may be on a first in first out basis. Where, for example, storage router 22 is a fibre channel to SCSI router, these instructions are SCSI write instructions. In this manner multiple streams of data blocks received from associated hosts such as hosts 12 of FIG. 2, can be interleaved forming a single stream of instructions to write those data blocks to storage device 20.

Error module 74 represents program instructions for receiving error messages from storage device 12 related to an instruction to write a particular data block received from a particular host 12. Error module 74 is responsible for instructing storage network translator 50 to route (via an assigned address) an error message to the particular host that sent that data block and to copy (via an assigned address) the error message to the other hosts. In this manner, when storage device 12 encounters a problem, media agents 38 operating on hosts 12 can be instructed to stop sending data blocks and/or informed of the error and its repercussions. Such errors can be fatal read/write errors. Where storage device 12 includes a tape drive, the errors may correspond to a logical end of tape or a physical end of tape.

Status module 76 represents program instructions for acquiring and/or maintaining status information concerning instructions to write one or more blocks to storage device 20; Such status information can include the position a given data block has been written to a storage medium employed by storage device 20. Status module 76 is also responsible for receiving and responding to status requests. For example, a media agent 38 for a particular host 12 may send, via an assigned address, a status request immediately after sending the first data block for a file. That request may be to identify the position on a storage medium to which that data block has been written. In response, status module 76 returns, via the same address, data identifying that position to the particular host.

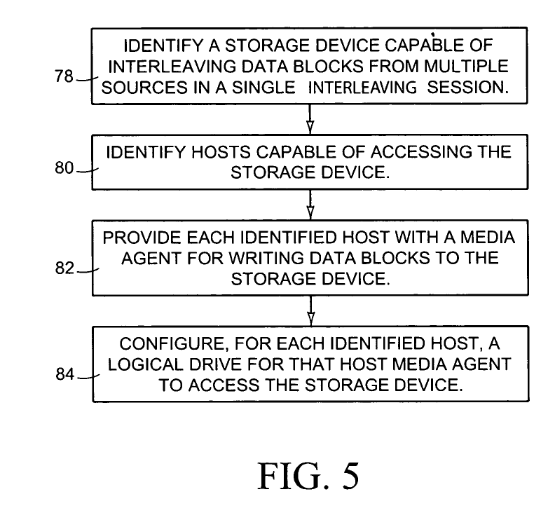

OPERATION: The operation of embodiments of the present invention will now be described with reference to FIGS. 5-7. FIG. 5 is an exemplary flow diagram illustrating steps take to prepare a number of hosts for sending data blocks to be interleaved. Initially, a storage device capable of interleaving data blocks from multiple hosts in a single interleaving session is identified (step 78). A group of hosts capable of accessing the storage device are also identified (step 80). Each of the identified hosts is provided with a media agent for writing data blocks to the identified storage device (step 82). For each identified host, a logical drive is configured through which that host's media agent can access the identified storage device (step 84). Each of steps 78-84, for example, may be performed by storage application 40 (FIG. 2).

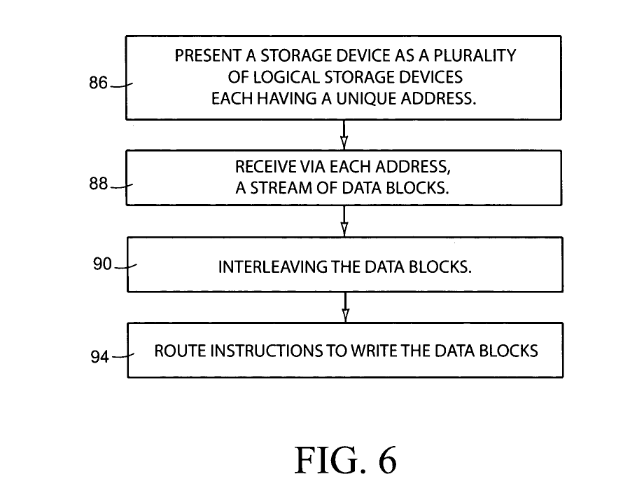

FIG. 6 is an exemplary flow diagram illustrating steps taken to interleave data blocks from multiple hosts in a single session. A storage device is presented as a plurality of logical storage devices each having a unique address (step 86). Step 88, for example, may involve presenting a plurality of SCSI LUNs for mapped to a sequential SCSI storage device capable of accepting only one input stream at a time.

A stream of data blocks is received via each address (step 88). Referring to the example of FIG. 2, each stream may be received from a different host 12 and each and sent by a media agent 38 for that host 12. Each of the media agents 38 is guided by storage application 40 in a coordinated effort to send multiple streams of data blocks from hosts 12 in a single interleaving session. To assemble the data blocks, each media agent 38 includes a header with each data block sent. The header for a given data block identifies a file and the data block's position in that file.

Data blocks received in step 88 are interleaved (step 90). This, for example, can involve sequentially placing data blocks in queue 52 (FIG. 2) as those data blocks are received without regard to the host that sent the data block. Instructions to write the interleaved data blocks are then routed to storage device 20 (step 94).

CONCLUSION: The schematic diagrams of FIG. 1 illustrates an exemplary environment 10 in which embodiments of the present invention may be implemented. Implementation, however, is not limited to environment 10. The diagrams of FIGS. 2-4 show the architecture, functionality, and operation of various embodiments of the present invention. A number of the blocks are defined as programs. Each of those blocks may represent in whole or in part a module, segment, or portion of code that comprises one or more executable instructions to implement the specified logical function(s). Each block may represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, infrared, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagram of FIGS. 5 and 6 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A method for interleaving, comprising:
presenting a physical storage device as a plurality of logical storage devices each having a unique address;
receiving via each address, a stream of data blocks;
interleaving the data blocks; and
routing instructions to write the interleaved data blocks to the storage device in a single interleaving session.

2. The method of claim 1, wherein the storage device is a sequential device that only supports a single input stream.

3. The method of claim 1, further comprising:
providing each of a plurality of hosts with a media agent; and
instructing each media agent to send, for a corresponding one of the hosts, a stream of data blocks to be interleaved with data blocks sent by the other media agents.

4. The method of claims 3, further comprising a central application coordinating operations of the media agents within the single interleaving session.

5. The method of claim 1, wherein interleaving comprises interleaving the data blocks in a queue and wherein routing comprises routing instructions to write the interleaved data blocks from the queue on a first in first out basis.

6. The method of claim 1, wherein the storage device is a sequential SCSI device that only supports a single input stream and wherein presenting comprises presenting a plurality of SCSI LUNs each mapped to the storage device.

7. The method of claim 6, wherein:
receiving comprises receiving, from each host, a stream of data blocks over a SCSI LUN assigned to that host; and
routing comprises, for each data block received, routing a SCSI write instruction to the storage device.

8. The method of claim 1, further comprising:
receiving a communication from the storage device corresponding to a data block received from a particular host;
routing the communication to the particular host; and
copying the communication to each of the other hosts.

9. The method of claim 8, wherein receiving a communication comprises receiving an error message from the storage device corresponding instruction to write to a data block received from a particular host.

10. The method of claim 1, further comprising:
receiving, from the storage device, status information corresponding to an instruction to write a particular data block received from a particular host;
receiving a status request from the particular host;
returning the status information to the particular host.

11. The method of claim 10, wherein receiving status information corresponding to an instruction to write a particular data block received from a particular host comprises receiving data identifying a position on a storage medium to which the particular data block was written.

12. A method for interleaving, comprising:
presenting a physical storage device as a plurality of logical storage devices each having a unique address;
providing each of a plurality of hosts with a media agent having access to a corresponding data source for that host;
assigning each media agent one of the unique addresses for sending data blocks from a corresponding data source to the storage device
receiving, via each unique address, a stream of data blocks;
interleaving the data blocks; and
routing instructions to write the interleaved data blocks to the storage device in a single interleaving session.

13. The method of claim 12, wherein the sending includes each media agent inserting header information into each data block to be sent.

14. The method of claim 13, wherein, inserting header information comprises, for each data block to be sent, inserting header information that identifies a file the data block is from and the data block's position within the file.

15. The method of claim 12, further comprising:
receiving an error message from the storage device corresponding to a data block received from a particular media agent;
routing the error message to the particular media agent; and
copying the error message to each of the other media agents.

16. The method of claim 12, further comprising each media agent including in the stream of data blocks a status request.

17. The method of claim 16, wherein each status request is a request for a file position on a storage medium being used by the storage device and is positioned in a corresponding stream of data blocks immediately following the fist data block of a particular file whose position is being requested.

18. The method of claim 12, further comprising:
supplying each media agent with a list of files contained on the data source corresponding to that media agent; and
each media agent identifying, on its corresponding data source, a list of data blocks for the list of files provided to that media agent and sending a stream of those data blocks the storage device via the unique address assigned to that media agent.

19. A computer readable medium having instructions for:
presenting a physical storage device as a plurality of logical storage devices each having a unique address;
receiving via each address, a stream of data blocks;
interleaving the data blocks; and
routing instructions to write the interleaved data blocks to the storage device in a single interleaving session.

20. The medium of claim 19, wherein the instructions for interleaving include instructions for interleaving the data blocks in a queue and wherein the instructions for routing include instructions for routing instructions to write the interleaved data blocks from the queue to a storage device in the single interleaving session on a first in first out basis.

21. The medium of claim 20, wherein the instructions for presenting associating include instructions for presenting a plurality of SCSI LUNs mapped to the storage device.

22. The medium of claim 21, wherein the instructions for:
receiving include instructions for receiving, via each SCSI LUN, a stream of data blocks; and
routing include instructions for, for each data block received, routing a SCSI write instruction to the storage device.

23. The medium of claim 22, wherein the instructions for interleaving include instructions for interleaving the data blocks in a queue and wherein the instructions for routing include instructions for, for each data block in the queue, routing a SCSI write instruction to the storage device on a first in first out basis.

24. The medium of claim 19 having further instructions for:
receiving a communication from the storage device corresponding to a data block received via one of the unique addresses;
routing the communication to that unique address; and
copying the communication to each of the other unique addresses.

25. The medium of claim 24, wherein the instructions for receiving a communication include instructions for receiving an error message from the storage device corresponding instruction to write to a data block received via one of the unique addresses.

26. The medium of claim 19, having further instructions for:
receiving, from the storage device, status information corresponding to an instruction to write a particular data block received via a particular one of the unique addresses;
receiving a status request via the particular address; returning the status information via the particular address.

27. The medium of claim 26, wherein the instructions for receiving status information corresponding to an instruction to write a particular data block received via a particular one of the unique addresses include instructions for receiving data identifying a position on a storage medium to which the particular data block was written.

28. A storage router, comprising:
a network interface;
a storage device interface;
a computer readable medium having instructions for:
presenting a physical storage device as a plurality of logical storage devices each having a unique address;
receiving via each address, a stream of data blocks;
interleaving the data blocks; and
routing, via the storage device interface, instructions to write the interleaved data blocks to the storage device in a single interleaving session; and.
a processor for executing the instructions.

29. The storage router of claim 28, further comprising a queue, and wherein the instructions for interleaving include instructions for interleaving the data blocks in the queue and wherein the instructions for routing include instructions for routing instructions to write the interleaved data blocks from the queue on a first in first out basis.

30. The storage router of claim 28, wherein the instructions for presenting include instructions for presenting a plurality of SCSI LUNs mapped to the storage device.

31. The storage router of claim 30, wherein the instructions for:
receiving include instructions for receiving, via each SCSI LUN, a stream of data blocks; and
routing include instructions for, for each data block received, routing a SCSI write instruction to the storage device.

32. The storage router of claim 31 further comprising a queue and wherein the instructions for interleaving include instructions for interleaving the data blocks in the queue and wherein the instructions for routing include instructions for, for each data block in the queue, routing a SCSI write instruction to the storage device on a first in first out basis.

33. The storage router of claim 28 having further instructions for:
receiving a communication from the storage device corresponding to a data block received via a particular one of the unique addresses;
routing the communication to the particular address; and
copying the communication to each of the other unique addresses.

34. The storage router of claim 33, wherein the instructions for receiving a communication include instructions for receiving an error message from the storage device corresponding instruction to write to a data block received via a particular one of the unique addresses.

35. The storage router of claim 28, having further instructions for:
receiving, from the storage device, status information corresponding to an instruction to write a particular data block received via a particular one of the unique addresses;
receiving a status request via the particular address;
returning the status information to the particular address.

36. The storage router of claim 35, wherein the instructions for receiving status information corresponding to an instruction to write a particular data block received via a particular one of the unique addresses include instructions for receiving data identifying a position on a storage medium to which the particular data block was written.

37. A system for interleaving, comprising:
a sequential storage device capable of supporting only a single input stream;
a plurality of media agents, each media agent having access to a corresponding data source for a particular host, each media agent being operable to send a stream of data blocks assembled from that media agent's corresponding data source; and
a storage router in communication with the hosts and the storage device, the storage router being operable to
present the storage device as a plurality of logical storage devices each having a unique address;
receive via each address, a stream of data blocks;
interleave the data blocks; and
route, via the storage device interface, instructions to write the interleaved data blocks to the storage device in a single interleaving session.

38. The system of claim 37, further comprising a storage application operable to coordinate the operations of the media agents in a single interleaving session.

39. The system of claim 37, wherein the storage router is operable to:
receive a communication from the storage device corresponding to a data block received via a particular address;
route the communication to the particular address; and copy the communication to each of the other addresses.

40. The system of claim 39, wherein the storage router is operable to receive a communication in the form of an error message corresponding to an instruction to write to a data block received via a particular address.

41. The system of claim 41, wherein the storage router is operable to:
receive, from the storage device, status information corresponding to an instruction to write a particular data block received via a particular address;
receive a status request via the particular address; and
return the status information to the particular address.

42. The system of claim 41, wherein receiving status information corresponding to an instruction to write a particular data block received via a particular address comprises receiving data identifying a position on a storage medium to which the particular data block was written.

43. A system for interleaving, comprising:
means for presenting a storage device as a plurality of logical storage devices each having a unique address;
means for receiving via each address, a stream of data blocks;
means for interleaving the data blocks; and
means for routing, via the storage device interface, instructions to write the interleaved data blocks to the storage device in a single interleaving session.
